(19) United States
(12) Patent Application Publication
(10) Pub. No.: US 2022/0308869 A1
(43) Pub. Date: Sep. 29, 2022

(54) COMPUTER MANAGEMENT OF MICROSERVICES FOR MICROSERVICE BASED APPLICATIONS

(71) Applicant: International Business Machines Corporation, Armonk, NY (US)

(72) Inventors: Rakesh Jain, San Jose, CA (US); Nitin Ramchandani, San Jose, CA (US); Thomas Downes Griffin, Campbell, CA (US); Divyesh Jadav, San Jose, CA (US)

(21) Appl. No.: 17/213,454

(22) Filed: Mar. 26, 2021

(51) Int. Cl. G06F 9/28; G06F 9/50

(52) U.S. Cl. CPC G06F 9/28; G06F 9/5027

(57) ABSTRACT

A plurality of executing microservices associated with respective features of an application are managed using a computer. The microservices are operating within a container orchestrator platform. Calls made to a plurality of microservices related to an application running on a container orchestrator platform are traces by the computer. A status map is generated by the computer of the plurality of microservices related to the application based on the tracing of the calls. The status map is published such that the status map is accessible to the plurality of microservices, and an action by one of the microservices of the plurality of microservices in response to the status map is initiated.

### BACKGROUND

A large software application can use microservices to decentralize application functions. In one example, a microservices architecture can include dividing functionality of a software application into smaller independently running microservices. Applications can use light weight containers to deploy Container Orchestrator Platforms (COPs) with many containers running to create an application.

Applications can be microservices based, and legacy applications can be converted into microservices based applications. Container Orchestration Platforms can be used in deployment and management of these applications.

One issue with the current use of COPs is that the COP has limited information about the application itself, typically knowing only a container or pod status. The application itself has limited or no information about several microservices which are being communicated with and relied on for application functions.

### SUMMARY

The present disclosure recognizes the shortcomings and problems associated with current techniques for managing microservice based applications within a container orchestrator platform.

The present invention provides a framework for microservices management by detecting and generating a record of microservices communications and dependencies, and allowing all the microservices in a group of microservices to view the status of other microservices.

In an aspect according to the present invention, a computer-implemented method analyzes and manages a plurality of executing microservices associated with respective features of an application. The microservices operate within a container orchestrator platform, and the method includes tracing, by a computer, calls made to a plurality of microservices related to an application having features, the application running on a container orchestrator platform. The method includes generating, by the computer, a status map relating the application features to the plurality of microservices, respectively, based on the tracing of the calls. The method includes publishing the status map such that the status map is accessible to the plurality of microservices, and initiating an action by one of the microservices of the plurality of microservices in response to the status map.

In a related aspect, the action can include enabling or disabling a feature of the application by a microservice.

In a related aspect, the microservices can be executed in an overlapping time period which includes simultaneously execution.

In a related aspect, the method can further include the computer receiving access permission to the application which is executing the plurality of microservices.

In a related aspect, the method can include each of the plurality of microservices self-publishing a status of their respective microservices, and updating the status map in response to receiving the self-published status at the computer.

In a related aspect, the method can include enabling or disabling various functions of the application related to one or more microservices of the plurality of microservices, in response to the microservices accessing the status map.

In a related aspect, the enabling or disabling can be based on availability of resources for the one or more microservices, respectively.

In a related aspect, tracing the calls made to a plurality of microservices can determine, in part, a response time for each of the plurality of microservices.

In a related aspect, the method can include mapping functions to the plurality of microservices; updating a function of the mapped functions from a corresponding microservice of the plurality of microservices, in response to feedback from the plurality of microservices received at the computer; and updating a status of the corresponding microservice, in response to the updating of the function.

In another aspect according to the present invention, a system uses a computer for analyzing and managing a plurality of executing microservices associated with respective features of an application. The microservices operate within a container orchestrator platform. The system includes a computer system comprising; a computer processor, a computer-readable storage medium, and program instructions stored on the computer-readable storage medium being executable by the processor, to cause the computer system to perform the following functions to; trace, by a computer, calls made to a plurality of microservices related to an application having features, the application running on a container orchestrator platform; generate, by the computer, a status map relating the application features to the plurality of microservices, respectively, based on the tracing of the calls; publish the status map such that the status map is accessible to the plurality of microservices; and initiate an action by one of the microservices of the plurality of microservices in response to the status map.

In a related aspect, the action can include enabling or disabling a feature of the application by a microservice.

In a related aspect, the microservices can be executed in an overlapping time period which includes simultaneously execution.

In a related aspect, the system further includes the computer receiving access permission to the application which is executing the plurality of microservices.

In a related aspect, the system can further include each of the plurality of microservices self-publishing a status of their respective microservices; and updating the status map in response to receiving the self-published status at the computer.

In a related aspect, the system can include enabling or disabling various functions of the application related to one or more microservices of the plurality of microservices, in response to the microservices accessing the status map.

In a related aspect, the enabling or disabling can be based on availability of resources for the one or more microservices, respectively.

In a related aspect, tracing the calls can be made to a plurality of microservices determines, in part, a response time for each of the plurality of microservices.

In a related aspect, the system can further include mapping functions to the plurality of microservices; updating a function of the mapped functions from a corresponding microservice of the plurality of microservices, in response to feedback from the plurality of microservices received at the computer; and updating a status of the corresponding microservice, in response to the updating of the function.

In another aspect according to the present invention, a computer program product analyzes and manages a plurality of executing micro services associated with respective features of an application, the microservices operate within a container orchestrator platform. The computer program product includes a computer readable storage medium having program instructions embodied therewith. The program instructions are executable by a computer to cause the computer to perform functions, by the computer, comprising the functions to: trace, by a computer, calls made to a plurality of microservices related to an application having features, the application running on a container orchestrator platform; generate, by the computer, a status map relating the application features to the plurality of microservices related to the application, respectively, based on the tracing of the calls; publish the status map such that the status map is accessible to the plurality of microservices; and initiate an action by one of the microservices of the plurality of microservices in response to the status map.

In a related aspect, the action can include enabling or disabling a feature of the application by a microservice.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system, system features or components, and methodology for analyzing and managing a plurality of executing microservices associated with respective features of an application, the microservices operating within a container orchestrator platform, according to an embodiment of the present disclosure.

FIG. 2 is a flow chart illustrating a method, implemented using the system shown in FIG. 1, for analyzing and managing a plurality of executing microservices associated with respective features of an application, the microservices operating within a container orchestrator platform, according to an embodiment of the present disclosure.

FIG. 3 is a functional schematic block diagram showing a series of operations and functional methodologies, for instructional purposes illustrating functional features of the present disclosure associated with the embodiments shown in the FIGS., for analyzing and managing a plurality of executing microservices associated with respective features of an application, the microservices operating within a container orchestrator platform.

FIG. 4A is a flow chart illustrating another method, which can be implemented, at least in part, using the system shown in FIG. 1 and continuing from the flow chart shown in FIG. 2, for analyzing and managing a plurality of executing microservices associated with respective features of an application, the microservices operating within a container orchestrator platform, according to an embodiment of the present disclosure.

FIG. 4B is a flow chart illustrating another method, which can be implemented, at least in part, using the system shown in FIG. 1 and continuing from the flow chart shown in FIG. 2, for analyzing and managing a plurality of executing microservices associated with respective features of an application, the microservices operating within a container orchestrator platform, according to an embodiment of the present disclosure.

FIG. 5 is a block diagram showing a system, which can be implemented, at least in part, using the system shown in FIG. 1, for analyzing and managing a plurality of executing microservices associated with respective features of an application, the microservices operating within a container orchestrator platform, according to an embodiment of the present disclosure.

FIG. 6 is a flow chart illustrating another method, which can be implemented, at least in part, using the system shown in FIG. 1, for analyzing and managing a plurality of executing microservices associated with respective features of an application, the microservices operating within a container orchestrator platform, according to an embodiment of the present disclosure.

FIG. 7 is a block diagram illustrating another system, which can be implemented, at least in part, using the system shown in FIG. 1, for analyzing and managing a plurality of executing microservices associated with respective features of an application, the microservices operating within a container orchestrator platform, according to an embodiment of the present disclosure.

FIG. 8 is a schematic block diagram depicting a computer system according to an embodiment of the disclosure which may be incorporated, all or in part, in one or more computers or devices shown in FIG. 1, and cooperates with the systems and methods shown in the FIGS.

FIG. 9 is a block diagram depicting a cloud computing environment according to an embodiment of the present invention.

FIG. 10 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It is understood that in the present disclosure, functions and features of an application are used interchangeably and refers to functions of the application, such as, a purchasing function or a data transfer function, etc. In one definition, a microservice performs a function of an application. It is understood that container is used interchangeably with pod, and refers to an application, plus all its dependencies, libraries and other binaries, and configuration files needed to run it, bundled into one package.

### EMBODIMENTS AND EXAMPLES

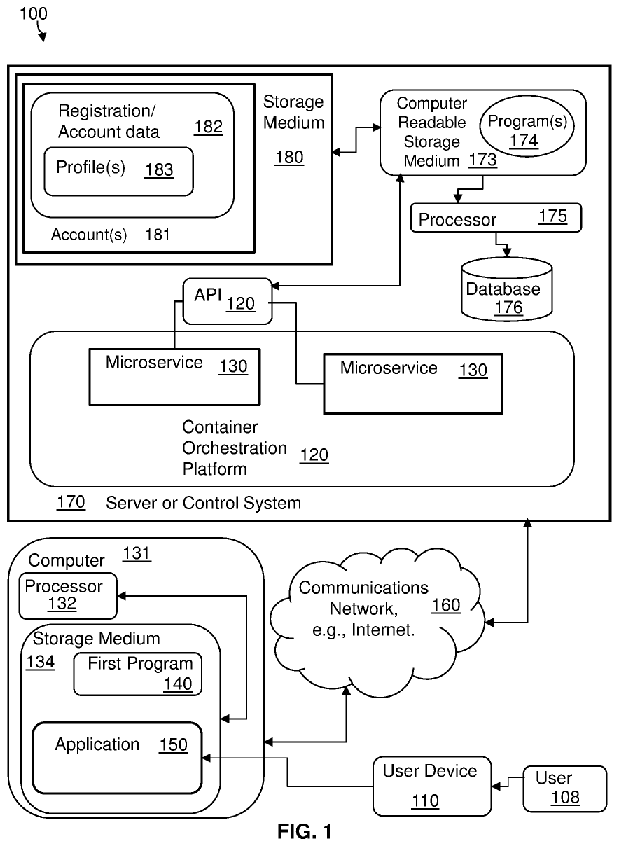

Referring to FIGS. 1, 2 and 3, a computer-implemented method 200 for analyzing and managing a plurality of executing microservices associated with respective features of an application, the microservices operating within a container orchestrator platform, according to an embodiment of the present disclosure. The method 200 includes a series of operational blocks for implementing an embodiment according to the present disclosure. The method 200 includes tracing, by a computer, calls made to a plurality of microservices 130 related to an application 150 having features 152. The microservices run on a container orchestrator platform, as in block 204. The microservices can be executed in an overlapping time period which includes simultaneous execution of the microservices. The tracing can include polling, or alternatively calling to a microservice, and receiving in return a return signal, or other such negotiation between two electronic participants using established protocols of communication.

Referring to FIG. 1, a system 100 according to an embodiment of the present disclosure includes a server 170 having a container platform 120. Microservices 130 are in the container platform 120. An API 120 (Application Programming Interface) communicates with the microservices. The API is in communication with a computer readable storage medium 173 which can include one or more software programs 174. The server also includes a processor 175 and a database 176. A storage medium 180 can include registration information or account data 182, as well as profiles 183 regarding accounts 181. The server 170 communicates with a computer 131 via a communications network, e.g., the Internet. The computer 131 includes a processor communicating with a storage medium 134 having a first program 140. The computer includes an application 150. A user 108 using a user device 110 can access the application 150 using an input device (not shown).

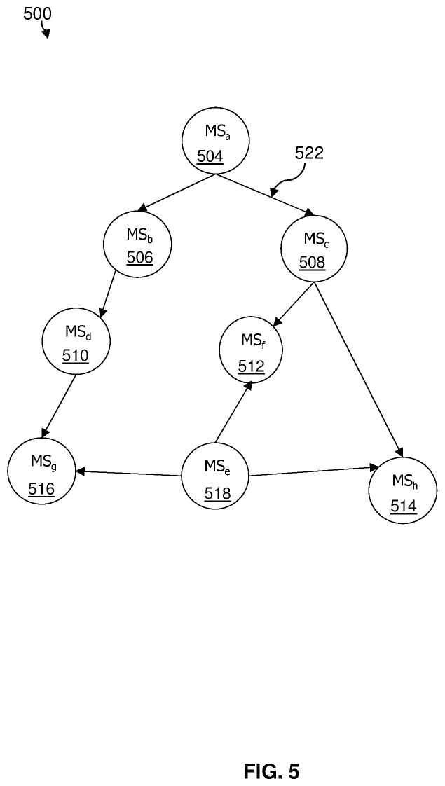

The method 100 includes generating, by the computer, a status map of the plurality of microservices related to features of the application based on the tracing of the calls, as in block 208. One example of an application feature to microservices status map 500 is shown in FIG. 5, and is also referred to herein as a status map as defined herein. For example, a status map can show each of a plurality of microservices and connections elements such as arrows or lines to show connections to features of the application, respectively.

The method 100 includes publishing the status map such that the status map is accessible to the plurality of microservices, as in block 212. For example, the computer can publish the status map by outputting the status map to all micro services, or in another example, storing the status map in a common location allowing access from each of the plurality of microservices. In a further example, the publishing can include broadcasting of a status. In another example, the database used by COP for managing the states of containers and other deployment artifacts, can be a common location.

The method 100 includes initiating an action by one of the microservices of the plurality of microservices in response to the status map, as in block 216.

In one example, the action can include enabling or disabling a microservice, as in block 220. For example, the computer can enable a first microservice in response to accessing the status map which indicates that the first microservice is disabled, and the computer assesses or determines that the application needs to or will need to access the first microservice.

### Other Embodiments and Examples

In one example, microservices can be are executed in an overlapping time period which includes simultaneously execution. For example, one or more microservices can be executing program instructions in the same time period, or in overlapping time periods, wherein any overlapping time periods or same time period is simultaneously.

In another example, the computer can receive access permission to the application, wherein the application is executing the plurality of microservices. For example, the computer is allowed to access the application for data communication.

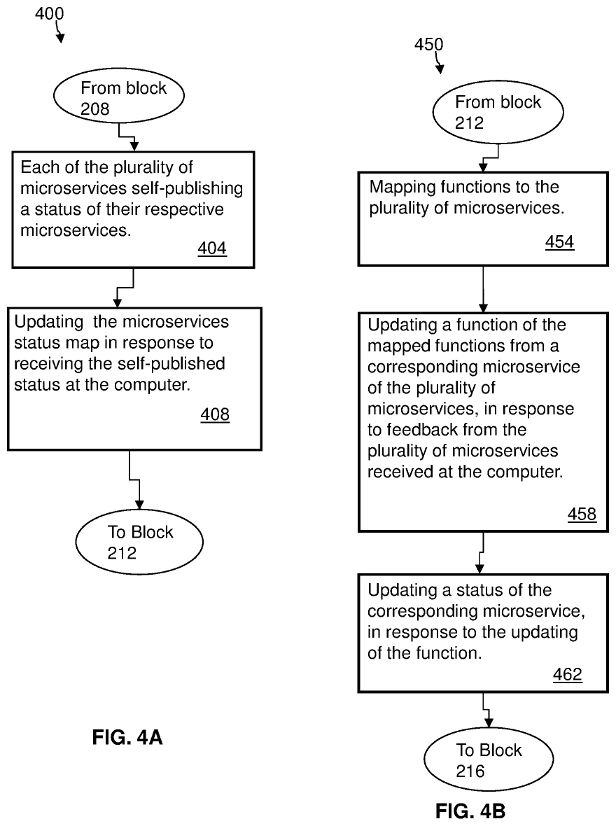

Referring to FIG. 4A, in another embodiment according to the present disclosure, a method 400 can continue from the method 200, continuing from block 208 of the method 200 such that each of the plurality of microservices self-publishing a status of their respective microservices, as in block 404. The method 400 includes updating the status map in response to receiving the self-published status at the computer, as in block 408. The method continues to block 212 of the method 200.

In one example, enabling or disabling various functions of the application related to one or more microservices of the plurality of microservices, is in response to the microservices accessing the status map.

In another example, the enabling or disabling can be based on availability of resources for the one or more microservices, respectively.

In another example, tracing the calls made to a plurality of microservices determines, in part, a response time for each of the plurality of microservices.

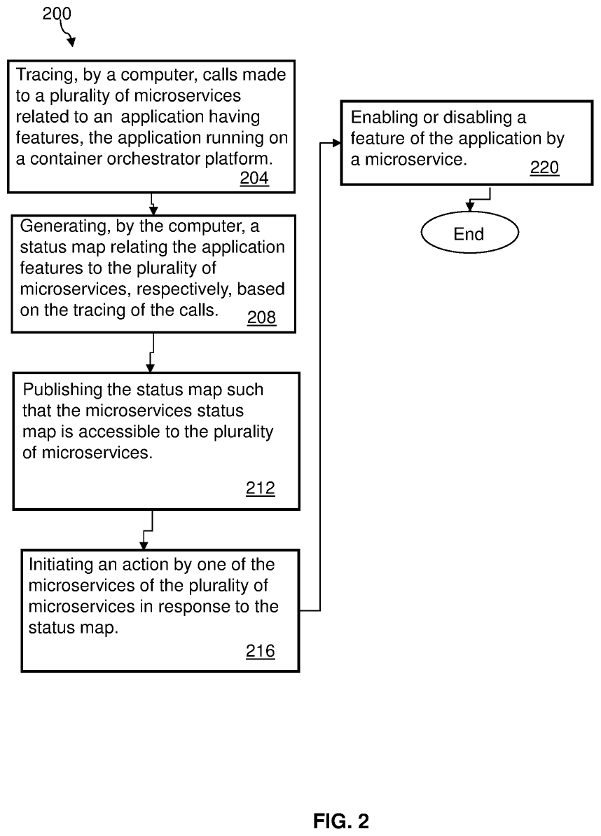

Referring to FIG. 4B, in another embodiment according to the present disclosure, a method 450 can continue from block 212 of the method 200 shown in FIG. 2, where the method 450 includes mapping functions to the plurality of microservices, as in block 454. The method includes updating a function of the mapped functions from a corresponding microservice of the plurality of microservices, in response to feedback from the plurality of microservices received at the computer, in block 458. The method includes updating a status of the corresponding microservice, in response to the updating of the function, as in block 462.

### Other Embodiments and Examples

Referring to FIG. 1, the user device 110 can communicate with an application 150 stored on a storage medium 134 on a computer 131. The computer 131 having a processor 132 and a storage medium 134 where a first program or application 140, can be stored. The first application can embody the features of the method of the present disclosure as instructions. The user can connect to a server or control system 170 using the computer 131. The first program 140 can embody the method of the present disclosure and can be stored on the computer readable storage medium 134. The computer 131 can use the processor 132 for executing the first program or application/software 140. The computer 131 can communicate with a communications network 160, e.g., the Internet, and communicate with the server 170 via the communications network 160.

It is understood that the computer 131 is representative of similar devices which can be for other user, as representative of such devices, which can include, mobile devices, smart devices, laptop computers etc. In another example and embodiment, profiles can be saved for users/participants.

In one example, the system of the present disclosure can include a server or control system 170 communicating with the user device 130 via a communications network 160. The control system can incorporate all or part of an application or software for implementing the method of the present disclosure. The control system can include a computer readable storage medium 180 where account data and/or registration data 182 can be stored. User profiles 183 can be part of the account data and stored on the storage medium 180. The control system can include a computer 172 having computer readable storage medium 173 and software programs 174 stored therein. A processor 175 can be used to execute or implement the instructions of the software program. The control system can also include a database 176.

In one example, a user can register or create an account using the server or control system 170 which can include one or more profiles 183 as part of registration and/or account data 182. The registration can include profiles for each user having personalized data. For example, users can register using a website via their computer and GUI (Graphical User Interface) interface. The registration or account data 182 can include profiles 183 for an account 181 for each user. Such accounts can be stored on the system or control system 170, which can also use the database 176 for data storage.

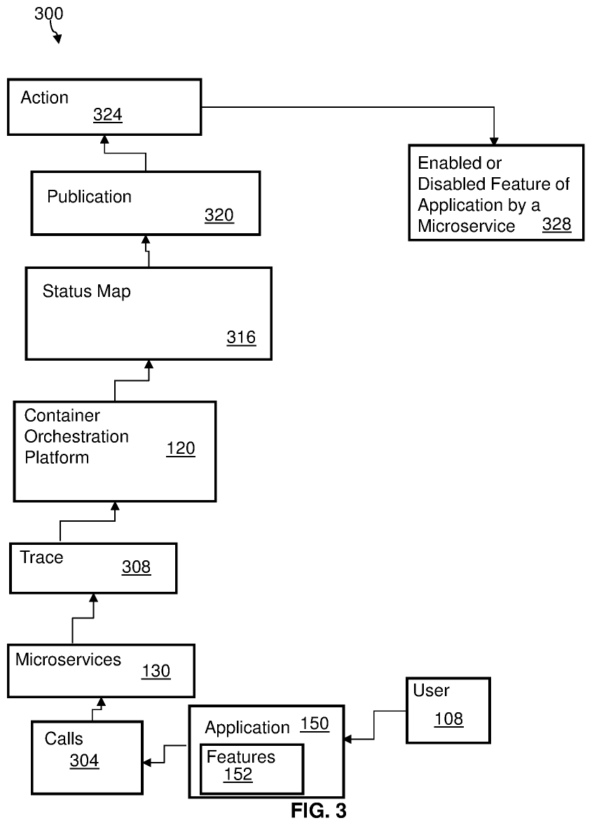

Additionally, the method and system is discussed with reference to FIG. 3, which is a functional system 300 which includes components and operations for embodiments according to the present disclosure, and is used herein for reference when describing the methods and systems of the present disclosure. Additionally, the functional system 300, according to an embodiment of the present disclosure, depicts functional operation indicative of the embodiments discussed herein.

Referring to FIG. 3, a user 108 accesses the application 150 which in turn initiates calls 304 for microservices 130. The calls are traced 308 for the microservices running on a container orchestration platform 120. The method and system according to the present disclosure generates a status map 316 for publication 320. An action 324 is initiated by the method and system which can include, for example, enabling or disabling a feature of the application by a microservices 328. In another example, features of the application can be enabled or disabled by respective microservices.

### More Embodiments and Examples

Generally, a large software application is composed of multiple different microservices, each microservice providing a functionality of the application. The features or functions provided by the application have dependency on the availability of different microservices.

A microservice itself may include multiple containers or pods. The status of a microservice may be more important to the application status than the status of individual containers or pods in the microservice. The dependency of each of a plurality of microservices among the plurality of microservices can be used to create a dependency graph. The features or functions of an application can be directly related to different sets of microservices, and can be shown or illustrated in a dependency graph. Embodiments of the present disclosure can include a framework for creation of a microservices dependency graph. The dependency graph and microservice status can be provided such that the information in the graph can be consumed by each microservice within the application. Embodiments can include mapping application features or functions including microservices availability and a dependency graph. Thereby, an application can detect and receive information provided by the mapping and dependency graph, thus be self-aware, about the availability of micro services the application depends on, and thereby enable/disable features of the application via enabling/disabling microservices.

Now referring to FIG. 5, a microservices graph 500 includes microservices (MS) and the arrows 522 depict interaction between the microservices. For example, MSa 504 is connected to MSb 506 and MSc 508. MSb 506 is confectioned to MSd 510 and MSq 516. MSc is connected to MSf 512 and MSh 514. MSe 518 is connected to MSh 514, MSf 512, and MSq 516.

In one example, a microservices based application can be deployed in a COP. A manual or automatic testing of an application can be initiated and completed by performing actions on different features or functions of the application.

A call trace can be generated between different microservices identifying the caller and callee. As the call traverses between different microservices, a map is generated of the features and the ordered set of microservices. The ordering of microservices in the set determines which service is called first and then next and so on, an example of which is illustrated in FIG. 5.

Continuing, a new mechanism, for example, embodied as a program(s) or specific application software communicating with the application, can be provided by the COP which makes the features/functions of the microservices map available for consumption by all the microservices in the environment.

The top level microservice will be able to use the information from the microservices map to initiate an action, for example, disable a feature/transaction if any of microservices it is mapped to is not available. In another example, the top level microservice will be able to use the information from the microservices map to initiate another action, for example, enable a feature/transaction if any of microservices it is mapped to is available and requiring such feature. The same mechanism can be used to trace the time taken by different microservices, and if any microservice deviates from a normal trend, the feature status can be changed or mitigation steps can be initiated.

In one example, a microservice may include multiple pods and containers. In one example, some pods/containers may be unavailable, but the microservice will continue to perform normally because of internal details of how the microservice works.

Mechanisms can be used to tell status of individual pods/containers. The COP and/or other microservices have no way of knowing whether the microservice itself is available or not. The microservice itself needs to make this information (that is, its status) available to other microservices.

In another example, the present disclosure can include a system for monitoring the microservices based applications whereby the application includes multiple different microservices. Each microservice includes multiple containers/pods. Each microservice can publish its status of availability/readiness using its native capabilities. The system includes tracing the application features to calls made through different microservices. The system includes creating a map of features as subsets of microservices and on which each feature depends upon, in order of calls to the microservices. The system includes utilizing this map by COPs to include status of each microservice which can be used in monitoring systems and also to know the status of application. The map may be used by top level microservices so that they can enable/disable certain features/transactions based on the availability of microservices that the features are mapped to. The system can utilize the same tracing mechanism to determine the response time of each microservice helping in performance related issue resolutions. The application can use this mechanism to disable some less important/utilized features to ease load, in case of a heavy load or adverse traffic. Thus, the present disclosure improves performance of any application and executing computer system by lower load on a processor(s), memory demand, and/or power consumption. The COP can utilize the mechanism to self-heal or self-help the application based on microservice status, rather than container status.

Thereby, as in the examples above, the system can generate a self-publication of status by each microservice, thereby enabling the other micro services to know the status of each other, and the system can enable the microservices to take corrective actions (for example, disable some transaction if a microservice is not available).

Thereby, the system can make available the status of microservices to other microservices. Additionally, the system can generate a feature to status map, such that if the status of any microservice is down/unavailable the microservice offering that feature has the ability to turn the feature off or augment the feature behavior. Thereby, the application can be self-aware of other microservices and enable them to know which feature of the application is dependent on other microservices or which set of microservices.

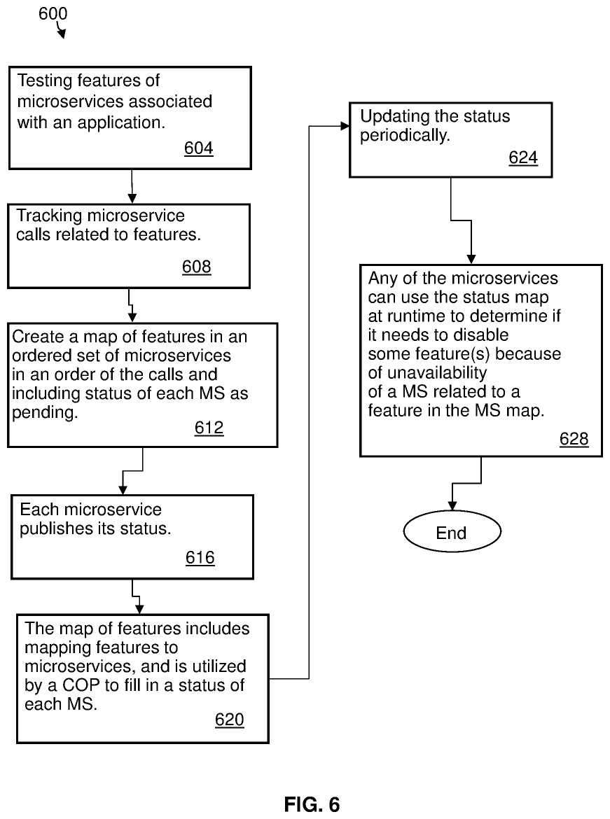

Referring to FIG. 6, a method 600 according to an embodiment of the present disclosure includes testing features, as in block 604, including testing features and functions of a plurality of microservices associated and communicating with an application. The method includes tracking microservices calls related to a feature, as in block 608.

The method includes creating a map of features in an ordered set of microservices in an order of the calls including status of each MS as pending, as in block 612. Each microservice publishes its status, as in block 616. That is, each microservice initiates and publishes the status of itself for viewing and/or reception by other microservice of the plurality of microservices. The method includes updating the status periodically, as in block 624. For example, periodically can range from a number of microseconds to a number of seconds or minutes. The method can include any of the microservices using the status map at runtime to determine if it needs to disable some feature(s) because of unavailability of a MS related to a feature in the MS map, as in block 628.

More specifically, referring to block 612, the feature-to-microservice map has a “pending” status. Then the microservice publishes the status in block 620. Therefore, in block 620, the status referred to in block 616 is filled in, that is, replacing the pending status with a real status or current status.

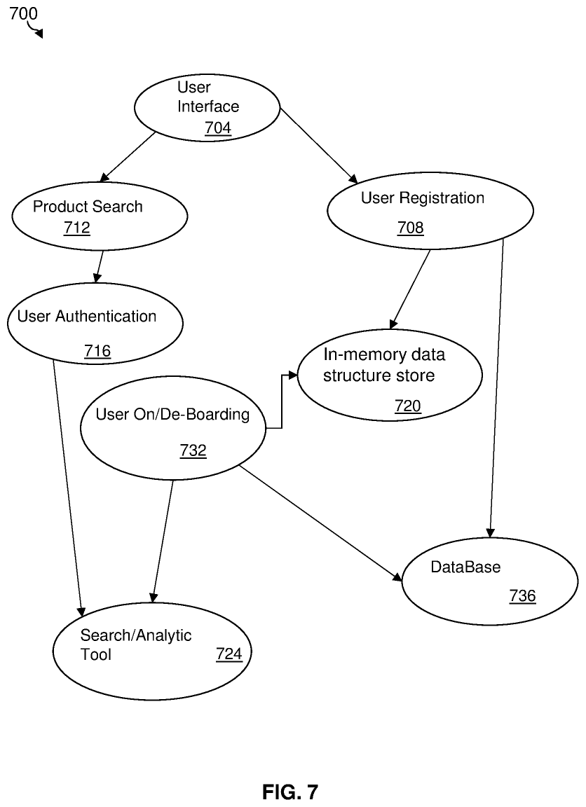

Referring to FIG. 7, a map 700 according to an embodiment of the present disclosure includes a user interface 704, as in block 704. The user interface 704 communicates with a product search 712 and user registration 708. The product search 712 communicates with a user authentication 716 which communicates a search/analytic tool 724. The user registration 708 communicates with a database 736 and an in-memory data structure store 720. User onboarding and de-boarding 732 communicates with the search and analytic tool 724, and the in-memory data structure store 720 and the database 736.

In one example, referring to FIG. 7, an ecommerce website can include users who create an account by registering to a site, and then users are able to search for the products they may want to buy. For example, microservices can enable creating an account, and a catalog search. The create account feature can depend on three microservices, user registration 708, database 736, and in-memory datastore 720.

Similarly, the catalog search feature can depend on microservices for a product search 712, a user authentication 716, and a search analytical tool 724. The two features can be used in the user interface 704 microservice. The method and system of the present disclosure can make available the map 700 to all microservices running in the COP. In the COP, feature >{microservices(name and status)}. For the above example, two features can depend on three different microservices: Features Microservices Create Account=>{User Registration(status), Database(status), In-memory datastore(status)}; Catalog Search=>{Product Search(status), User authentication(status), Search analytical tool(status)}.

A map with actual status value can be made available by COP to all the microservices. The user interface microservice can use this map to enable or disable the two features depending on status of one or more microservices on which the feature depends on. For example, if the User Authentication microservice is not available, i.e., its status is not green/on-line, then the user interface microservice will be able to disable the Catalog Search feature, because that feature depends on the microservice which is not available.

### Additional Examples and Embodiments

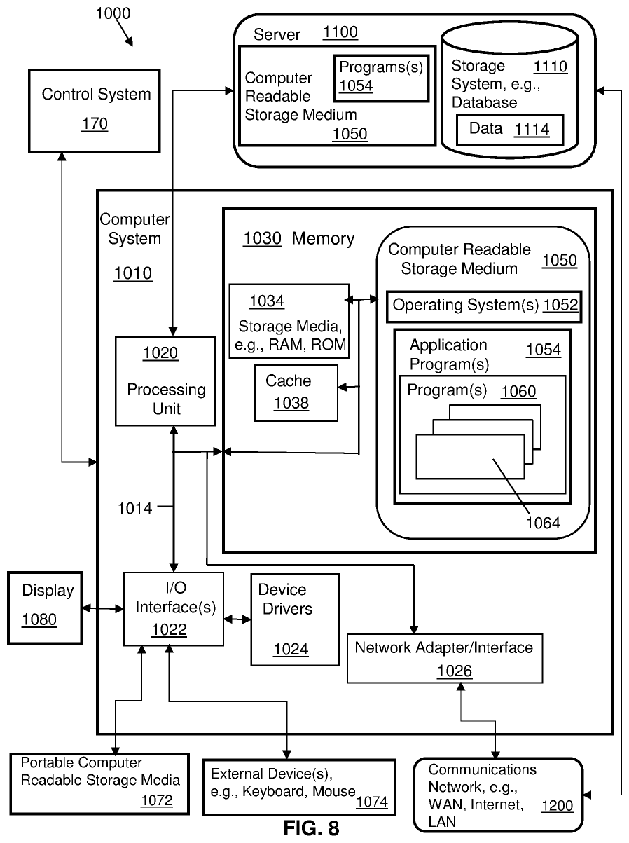

In the embodiment of the present disclosure shown in FIGS. 1 and 2, a computer can be part of a remote computer or a remote server, for example, remote server 1100 (FIG. 8). In another example, the computer 131 can be part of a server or control system 170 and provide execution of the functions of the present disclosure. A control system may be referred to in the present disclosure as any system which manages, in whole or part, functions of the methods and systems of the embodiments of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device 130 can include a computer 131 having a processor 132 and a storage medium 134 which stores a first application 140, and the computer includes a display 138. The application can incorporate program instructions for executing the features of the present disclosure using the processor 132. In another example, the mobile device application or computer software can have program instructions executable for a front end of a software application incorporating the features of the method of the present disclosure in program instructions, while a back end program or programs 174, of the software application, stored on the computer 172 of the control system 170 communicates with the mobile device computer and executes other features of the method. The control system 170 and the device (e.g., mobile device or computer) 130 can communicate using a communications network 160, for example, the Internet.

Thereby, the method 200 according to an embodiment of the present disclosure, can be incorporated in one or more computer programs or a first application 140 stored on an electronic storage medium 134, and executable by the processor 132, as part of the computer on mobile device. For example, a mobile device can communicate with the control system 170, and in another example, a device such as a video feed device can communicate directly with the control system 170. Other users (not shown) may have similar mobile devices which communicate with the control system similarly. The application can be stored, all or in part, on a computer or a computer in a mobile device and at a control system communicating with the mobile device, for example, using the communications network 160, such as the Internet. It is envisioned that the application can access all or part of program instructions to implement the method of the present disclosure. The program or application can communicate with a remote computer system via a communications network 160 (e.g., the Internet) and access data, and cooperate with program(s) stored on the remote computer system. Such interactions and mechanisms are described in further detail herein and referred to regarding components of a computer system, such as computer readable storage media, which are shown in one embodiment in FIG. 8 and described in more detail in regards thereto referring to one or more computer systems 1010.

Thus, in one example, a control system 170 is in communication with the computer 130, and the computer can include the first application or software 140. The computer 130, or a computer in a mobile device (not shown) communicates with the control system 170 using the communications network 160.

In another example, the control system 170 can have a front-end computer belonging to one or more users, and a back-end computer embodied as the control system.

Also, referring to FIG. 1, a device 130 can include a computer 131, computer readable storage medium 134, and operating systems, and/or programs, and/or a first software application 140, which can include program instructions executable using a processor 132. These features are shown herein in FIG. 1, and also in an embodiment of a computer system shown in FIG. 8 referring to one or more computer systems 1010, which may include one or more generic computer components.

The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Specifically, regarding the control system 170, a device(s) 130, or in one example devices which can belong to one or more users, can be in communication with the control system 170 via the communications network 160. In the embodiment of the control system shown in FIG. 1, the control system 170 includes a computer 172 communicating with a database 176 and one or more programs 174 stored on a computer readable storage medium 173. In the embodiment of the disclosure shown in FIG. 1, the device 130 communicates with the control system 170 and the one or more programs 174 stored on a computer readable storage medium 173. The control system includes the computer 172 having a processor 175, which also has access to the database 176.

The server 170 can include a storage medium 180 for maintaining a registration 182 of users and their devices for analysis of the audio input. Such registration can include user profiles 183, which can include user data supplied by the users in reference to registering and setting-up an account. In an embodiment, the method and system which incorporates the present disclosure includes the control system (generally referred to as the back-end) in combination and cooperation with a front end of the method and system, which can be the first application 140. In one example, the first application 140 is stored on a device, for example, a computer or device on location 130, and can access data and additional programs at a back end of the application, e.g., control system 170.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, as in the example shown in FIG. 1 of a device and computer 130 having the first application 140. The first application 140 is stored on the device or computer 130 and can access data and additional programs at the back end of the application, for example, in the program(s) 174 stored in the control system 170.

The program(s) 174 can include, all or in part, a series of executable steps for implementing the method of the present disclosure. A program, incorporating the present method, can be all or in part stored in the computer readable storage medium on the control system or, in all or in part, on a computer or device 130. It is envisioned that the control system 170 can not only store the profile of users, but in one embodiment, can interact with a website for viewing on a display of a device such as a mobile device, or in another example the Internet, and receive user input related to the method and system of the present disclosure. It is understood that FIG. 1 depicts one or more profiles 183, however, the method can include multiple profiles, users, registrations, etc. It is envisioned that a plurality of users or a group of users can register and provide profiles using the control system for use according to the method and system of the present disclosure.

### Still Further Embodiments and Examples

It is understood that the features shown in some of the FIGS., for example block diagrams, are functional representations of features of the present disclosure. Such features are shown in embodiments of the systems and methods of the present disclosure for illustrative purposes to clarify the functionality of features of the present disclosure.

The methods and systems of the present disclosure can include a series of operation blocks for implementing one or more embodiments according to the present disclosure. In some examples, operational blocks of one or more figures may be similar to operational blocks of another figure. A method shown in one figure may be another example embodiment which can include aspects/operations shown in another figure which was discussed previously.

### Additional Embodiments and Examples

Account data, for instance, including profile data related to a user, and any data, personal or otherwise, can be collected and stored, for example, in the control system 170. It is understood that such data collection is done with the knowledge and consent of a user, and stored to preserve privacy, which is discussed in more detail below. Such data can include personal data, and data regarding personal items.

In one example a user can register 182 have an account 181 with a user profile 183 on a control system 170, which is discussed in more detail below. For example, data can be collected using techniques as discussed above, for example, using cameras, and data can be uploaded to a user profile by the user.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for a learning model for analyzing data associated with items and assets.

In another example, the server or control system 170 can be all or part of an Artificial Intelligence (AI) system. For example, the control system can be one or more components of an AI system.

It is also understood that the method 200 according to an embodiment of the present disclosure, can be incorporated into (Artificial Intelligence) AI devices, which can communicate with respective AI systems, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Further Additional Examples and Embodiments

Referring to FIG. 8, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 170, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### Other Aspects and Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Additional Aspects and Examples

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

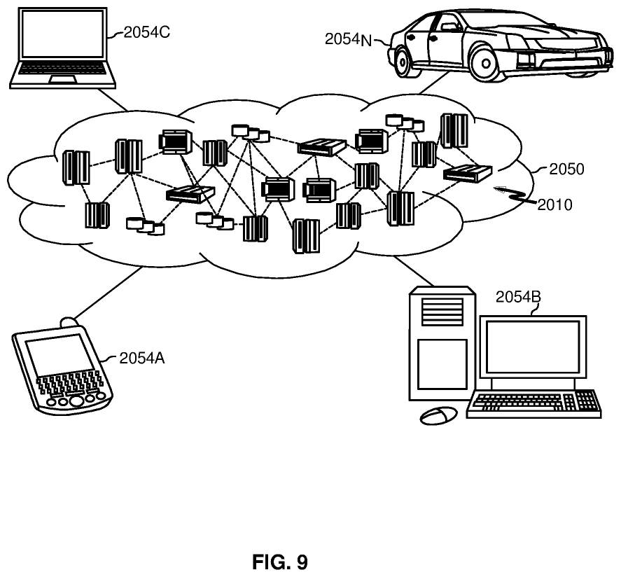

Referring now to FIG. 9, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

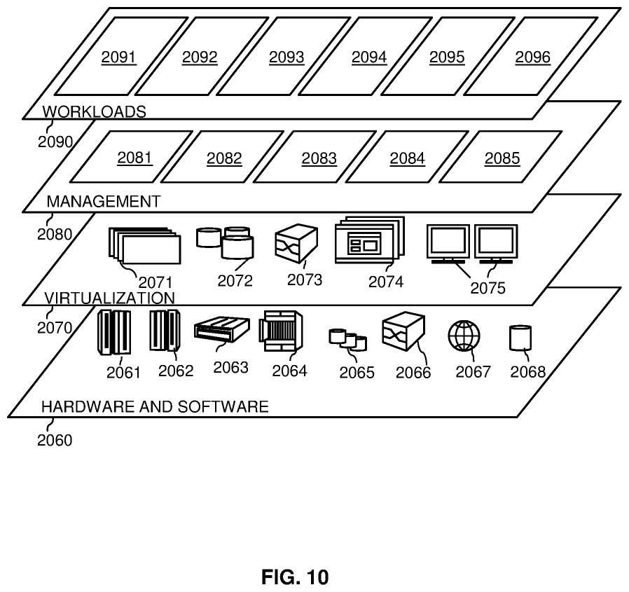

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and microservices management 2096, for example, for analyzing and managing microservices within a container orchestrator platform.

What is claimed is:

1. A computer-implemented method for analyzing and managing a plurality of executing microservices associated with respective features of an application, the microservices operating within a container orchestrator platform, comprising:
tracing, by a computer, calls made to a plurality of microservices related to an application having features, the application running on a container orchestrator platform;
generating, by the computer, a status map relating the application features to the plurality of microservices, respectively, based on the tracing of the calls;
publishing the status map such that the status map is accessible to the plurality of microservices; and
initiating an action by one of the microservices of the plurality of microservices in response to the status map.

2. The method of claim 1, wherein the action includes enabling or disabling a feature of the application by a microservice.

3. The method of claim 1, wherein the microservices are executed in an overlapping time period which includes simultaneously execution.

4. The method of claim 1, further comprising:
the computer receiving access permission to the application which is executing the plurality of microservices.

5. The method of claim 1, further comprising:
each of the plurality of microservices self-publishing a status of their respective microservices; and
updating the status map in response to receiving the self-published status at the computer.

6. The method of claim 1, further comprising:
enabling or disabling various functions of the application related to one or more microservices of the plurality of microservices, in response to the microservices accessing the status map.

7. The method of claim 6, wherein the enabling or disabling is based on availability of resources for the one or more microservices, respectively.

8. The method of claim 1, wherein tracing the calls made to a plurality of microservices determines, in part, a response time for each of the plurality of microservices.

9. The method of claim 1, further comprising:
mapping functions to the plurality of microservices;
updating a function of the mapped functions from a corresponding microservice of the plurality of microservices, in response to feedback from the plurality of microservices received at the computer; and
updating a status of the corresponding microservice, in response to the updating of the function.

10. A system using a computer for analyzing and managing a plurality of
executing microservices associated with respective features of an application, the microservices operating within a container orchestrator platform, which comprises:
a computer system comprising; a computer processor, a computer-readable storage medium, and program instructions stored on the computer-readable storage medium being executable by the processor, to cause the computer system to perform the following functions to;
trace, by a computer, calls made to a plurality of microservices related to an application having features, the application running on a container orchestrator platform;
generate, by the computer, a status map relating the application features to the plurality of microservices, respectively, based on the tracing of the calls;
publish the status map such that the microservices status map is accessible to the plurality of microservices; and
initiate an action by one of the microservices of the plurality of microservices in response to the status map.

11. The system of claim 10, wherein the action includes enabling or disabling a feature of the application by a microservice.

12. The system of claim 10, wherein the microservices are executed in an overlapping time period which includes simultaneously execution.

13. The system of claim 10, further comprising:
the computer receiving access permission to the application which is executing the plurality of microservices.

14. The system of claim 10, further comprising:
each of the plurality of microservices self-publishing a status of their respective microservices; and
updating the status map in response to receiving the self-published status at the computer.

15. The system of claim 10, further comprising:
enabling or disabling various functions of the application related to one or more microservices of the plurality of microservices, in response to the microservices accessing the status map.

16. The system of claim 15, wherein the enabling or disabling is based on availability of resources for the one or more micro services, respectively.

17. The system of claim 10, wherein tracing the calls made to a plurality of microservices determines, in part, a response time for each of the plurality of microservices.

18. The system of claim 10, further comprising:
mapping functions to the plurality of microservices;
updating a function of the mapped functions from a corresponding microservice of the plurality of microservices, in response to feedback from the plurality of microservices received at the computer; and
updating a status of the corresponding microservice, in response to the updating of the function.

19. A computer program product for analyzing and managing a plurality of executing microservices associated with respective features of an application, the microservices operating within a container orchestrator platform, the computer program product comprising a computer readable storage medium having program instructions embodied therewith, the program instructions executable by a computer to cause the computer to perform functions, by the computer, comprising the functions to:
trace, by a computer, calls made to a plurality of microservices related to an application having features, the application running on a container orchestrator platform;
generate, by the computer, a status map relating the application features to the plurality of microservices, respectively, based on the tracing of the calls;
publish the status map such that the status map is accessible to the plurality of microservices; and
initiate an action by one of the microservices of the plurality of microservices in response to the status map.

20. The computer program product of claim 19, wherein the action includes enabling or disabling a feature of the application by a microservice.
